(19) United States
(12) Patent Application Publication
(10) Pub. No.: US 2006/0251119 A1
(43) Pub. Date: Nov. 9, 2006

(54) Methods and apparatus to setup end-to-end flows in wireless mesh networks

(76) Inventor: Sridhar Ramesh, Bangalore (IN)

Correspondence Address: TEXAS INSTRUMENTS INCORPORATED, P O BOX 655474, M/S 3999, DALLAS, TX, 75265, US

(21) Appl. No.: 11/410,865

(22) Filed: Apr. 25, 2006

Related U.S. Application Data
(60) Provisional application No. 60/678,039, filed on May 4, 2005.

(51) Int. Cl. H04J 3/22

(52) U.S. Cl. 370/468

(57) ABSTRACT

Methods and apparatus to setup end-to-end flows in wireless mesh networks are disclosed. A disclosed example method of performing a distributed flow setup for a wireless mesh network comprises receiving a broadcast setup request for a wireless data stream at a first wireless mesh point of the wireless mesh network; determining if the requested wireless data stream is acceptable at the first wireless mesh point based upon at least one of a resource allocation table associated with the first wireless mesh point or a resource schedule table associated with the first wireless mesh point; sending a wireless data stream setup acceptance if the requested wireless data stream is acceptable; and updating the at least one of the resource allocation table associated with the first wireless mesh point or the resource schedule table associated with the first wireless mesh point to reflect the requested wireless data stream if the wireless data stream is accepted by the first wireless mesh point.

### RELATED APPLICATIONS

This patent claims priority from U.S. Provisional Application Ser. No. 60/678,039, entitled “Distributed end-to-end flow set-up scheme for wireless mesh networks” which was filed on May 5, 2005. U.S. Provisional Application Ser. No. 60/678,039 is hereby incorporated by reference in its entirety.

### FIELD OF THE DISCLOSURE

This disclosure relates generally to wireless mesh networks and, more particularly, to methods and apparatus to setup end-to-end flows in wireless mesh networks.

### BACKGROUND

Wireless local area networks (WLANs) have evolved to become a popular networking technology of choice for residences, enterprises and/or commercial locations (e.g., hotspots). An example WLAN is based on the Institute of Electrical and Electronics Engineers (IEEE) 802.11x family of standards. The coverage area (i.e., effective communication range) provided by access points within such a WLAN are limited, and, thus, hotspots and/or enterprise WLANs often utilize multiple access points connected via any variety of wired backbone and/or distribution system. Increasingly, wireless mesh networks are being deployed to obviate the need for the wired backbone and/or distribution system in such WLANs. In wireless mesh networks, wireless mesh points (a.k.a., mesh points, network nodes, nodes, etc.) are communicatively coupled via a plurality of wireless communication paths creating a mesh of communication paths amongst the mesh points. In wireless mesh networks, a first wireless device desiring to communicate with a second wireless device can do so via one or more wireless communication paths between one or more pairs of wireless mesh points (i.e., hops).

### BRIEF DESCRIPTION OF THE DRAWINGS

FIG. 1 is a schematic illustration of an example wireless mesh network.

FIG. 2 is an example resource allocation table.

FIG. 3 is an example flow setup request.

FIG. 4 is an example flow state table.

FIG. 5 is an example resource schedule table.

FIG. 6 is another example flow setup request.

FIG. 7 illustrates an example manner of implementing the example wireless mesh points of FIG. 1.

FIGS. 8, 9, 10, 11 and 12 are flowcharts representative of example machine accessible instructions that may be executed to implement the example wireless mesh points and/or, more generally, to perform end-to-end flow setup for the example wireless mesh network of FIG. 1.

FIG. 13 is a schematic illustration of an example processor platform that may be used and/or programmed to execute the example machine accessible instructions of FIGS. 8, 9, 10, 11 and/or 12 to implement the example wireless mesh points and/or, more generally, to perform end-to-end flow setup for the example wireless mesh network of FIG. 1.

### DETAILED DESCRIPTION

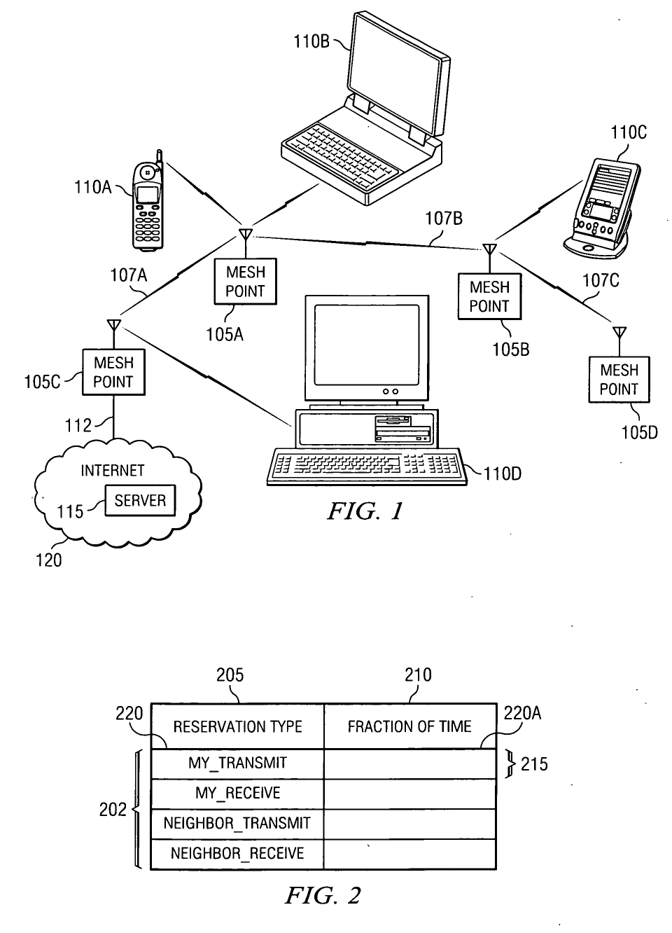

FIG. 1 is a schematic diagram of an example wireless mesh network. To provide wireless data and/or communication services (e.g., telephone services, Internet services, data services, messaging services, instant messaging services, electronic mail (email) services, chat services, video services, audio services, gaming services, etc.), the example wireless mesh network of FIG. 1 includes a plurality of wireless mesh points (a.k.a., mesh points, nodes, etc.), four of which are respectively designated in FIG. 1 with reference numerals 105A, 105B, 105C and 105D. Example wireless mesh points include wireless bridges, wireless repeaters, wireless routers, etc.

In the example of FIG. 1, the example mesh points 105A, 105B, 105C and 105D are communicatively coupled via a plurality of wireless communication paths (three of which are respectively designated in FIG. 1 with reference numeral 107A, 107B and 107C) to form any size, variety, topology, web and/or mesh of wireless communication paths. In the illustrated example, wireless communications and/or wireless communication paths are based on the Institute of Electrical and Electronics Engineers (IEEE) 802.11x family of standards.

As used herein, the term “neighboring mesh points” will be used to refer to mesh points that are communicatively coupled via a direct wireless communication path. For example, wireless mesh points 105B and 105D are neighboring mesh points. The term “neighborhood of a given mesh point” is be used herein to refer to the set of mesh points located physically near enough to the given mesh point and/or using one or more common wireless channels with the given mesh point such that there is a capability and/or possibility to transmit and/or receive one or more wireless signals between the given mesh point and the set of mesh points.

The example wireless mesh points 105A-D collectively provide wireless data and/or communication services via the example wireless communication paths 107A-C over a site, location, building, geographic area and/or geographic region. For example, the plurality of wireless mesh points may be arranged in a pattern and/or grid with abutting and/or slightly overlapping coverage areas such that any variety of fixed-location wireless device and/or mobile wireless device moving through and/or within an area communicatively covered by one or more of the plurality of wireless mesh points can, at all times, communicate with at least one of the wireless mesh points.

The plurality of wireless mesh points may provide wireless data and/or communication services to any of a plurality of fixed-location and/or mobile wireless devices. Example mobile wireless devices include a wireless telephone 110A (e.g., a cellular phone, a voice over Internet Protocol (VoIP) phone, etc.), a laptop computer 110B with wireless communication capabilities, a personal digital assistant (PDA) 110C, an MP3 player such as an iPod®, etc. Example fixed-location wireless devices include, for example, any variety of personal computer (PC) 110D with wireless communication capabilities.

In the example of FIG. 1, to allow the plurality of wireless devices 110A-D to communicate with devices and/or servers located outside the wireless mesh network, the example wireless mesh point 105C is communicatively coupled via any variety of communication path 112 to, for example, any variety of server 115 associated with a public and/or private network such as the Internet 120. The example server 115 may be used to provide, receive and/or deliver, for example, any variety of data, video, audio, telephone, gaming, Internet, messaging, electronic mail, etc. service. Additionally or alternatively, the example wireless mesh network of FIG. 1 may be communicatively coupled to any variety of private and/or enterprise communication network(s), computer(s), workstation(s) and/or server(s) to provide any variety of data and/or communication service(s).

Since the example wireless network illustrated in FIG. 1 is a mesh network, a communication path between two wireless devices (i.e., a forwarding path) may include more than one wireless communication link between any number of mesh point neighbors (i.e., any number of hops). For example, a wireless data flow from the example laptop 110B to the example server 115 of FIG. 1 occurs via a forwarding path that includes mesh point 105A (i.e., an originating mesh point), the wireless communication link 107A, the mesh point 105C (i.e., a destination mesh point) and the communication path 112. In this example, the wireless communication link 107A is used as a “hop” between the neighboring wireless mesh points 105A and 105C (i.e., to transfer any form of data between the neighboring mesh points). Likewise, an example wireless data flow from the PDA 110C to the personal computer 110D occurs via a forwarding path that includes the mesh point 105B (i.e., an originating mesh point), the wireless communication link 107B, the mesh point 105A (i.e., a forwarding mesh point), the wireless communication link 107A and the mesh point 105C (i.e., a destination mesh point). As such, communications between the PDA 110C and the personal computer 110D require the use of two (2) hops between two (2) pairs of neighboring wireless mesh points. In the example of FIG. 1, the selection, determination, routing, etc. of a wireless data flow along a forwarding path may occur via any variety of method(s) and/or technique(s).

In the illustrated example, data packets associated with a wireless data flow are transmitted along a forwarding path. That is, at each mesh point along the forwarding path the data packets are addressed, sent and/or forwarded to the next mesh point of the forwarding path and/or received from the previous mesh point of the forwarding path. In the example of FIG. 1, the data packets are sent and/or forwarded via any variety of data packet addressing scheme and/or method. In the example wireless mesh network of FIG. 1, data packets, frames, messages, beacons etc. may, alternatively or additionally, be sent via any variety of multicast address associated with all and/or a portion of the plurality of mesh points that form a wireless mesh network. An example multicast address is the quality of service (QoS) Management Multicast Address that may be used to address data packets, frames and/or messages to all mesh points of a wireless mesh network.

It will be readily apparent to persons of ordinary skill in the art that since wireless signals are used to transmit and/or forward the data packets for a given data flow, that mesh points other than the mesh points forming a forwarding path for the given data flow may have their reception of wireless signals interfered by the wireless signals used for the data flow. That is, a wireless signal associated with data packets and/or data flows may impinge on one or more mesh points that are neither the addressee nor mesh points on the forwarding path for the data packets. In other words, regardless of an address to which a wireless signal is transmitted by a given wireless mesh point, the wireless signal is a broadcast signal and, thus, may be detected, received and/or cause interference at any mesh point in the neighborhood of the given wireless mesh point. For instance, for the example data flow from the PDA 110C to the personal computer 110D discussed above, the mesh point 105D is a neighbor of mesh point 105B and, thus, when the mesh point 105B transmits data packets for the example data flow addressed to the mesh point 105A, the associated wireless signal transmitted by the mesh point 105B interferes with the reception at the mesh point 105D of wireless signals that occur concurrently to the associated wireless signal.

While this disclosure refers to the example wireless mesh network and/or the example wireless devices 110A-D of FIG. 1, the example wireless mesh network of FIG. 1 may be used to provide services to, from and/or between any alternative and/or additional variety and/or number of wired and/or wireless data and/or communication devices (e.g., telephone devices, personal digital assistants (PDA), laptops, etc.). Additionally, although for purposes of explanation, this disclosure refers to the example wireless mesh points 105A-C and/or the example wireless communication paths 107A-B illustrated in FIG. 1, any additional and/or alternative variety and/or number of communication systems, communication devices and/or communication paths may be used to implement a wired and/or wireless mesh network and/or provide data and/or communication services in accordance with the teachings disclosed herein.

Further, while for purposes of illustration, this disclosure references performing distributed end-to-end flow setup for wireless mesh networks, persons of ordinary skill in the art will readily appreciate that the apparatus and methods disclosed herein may additional or alternatively be applied to any type of mesh communication system and/or network.

In a wireless mesh network, all wireless mesh points and communication devices contend for access (i.e., transmission time) on the same and/or same set of wireless channels and/or frequencies. For example, the phone 110A and the laptop 110B cannot both simultaneously transmit using the same wireless channel since they would create interference at the example mesh point 105A. Likewise, the mesh point 105A cannot simultaneously receive wireless signals from the mesh point 105C and the laptop 110B via the same radio and/or wireless channel. However, if the mesh point 105A is not able to detect and/or receive wireless signals from the personal computer 110D, the personal computer 110D and the laptop 110B could transmit simultaneously using the same wireless channel as a wireless signal transmitted by the personal computer 110D would not interfere with the reception at the mesh point 105A of a wireless signal transmitted the laptop 110B.

As described above, each forwarding path consists of an origination mesh point, any number (including zero) of forwarding mesh points, and a destination mesh point. Further, there may be any number of mesh points in the neighborhoods of the origination, forwarding and/or destination mesh points (a.k.a. non-forwarding mesh points) that may be affected by transmissions occurring along the forwarding path. In the illustrated example of FIG. 1, when the setup of a new and/or changed wireless data flow is requested, each of the origination, the forwarding, the non-forwarding and the destination mesh points associated with the forwarding path of the new and/or changed data flow (i.e., affected mesh points) determine if the new and/or changed data flow would interfere with the transmission and/or reception of previously setup data flows at the mesh point. As described below, this is accomplished by transmitting (i.e., broadcasting) data flow setup requests along the forwarding path for the data flow such that each of the affected mesh points can determine if the requested data flow is acceptable. In the example network of FIG. 1, the data flow setup requests are addressed to the QoS Management Multicast Address.

Consider for now, a wireless mesh network operating with a single wireless channel and where each mesh point utilizes a single radio. The case of multiple channels and/or multiple radios will be discussed in more detail later. Let My_Transmit represent the fraction of time that mesh point 105A is transmitting, My_Receive represent the fraction of time that mesh point 105A is receiving, Neighbor_Transmit be an upper bound on the fraction of time that the neighboring mesh points of mesh point 105A are transmitting to wireless devices or mesh points other than 105A, and Neighbor_Receive be an upper bound on the fraction of time that the neighboring mesh points of mesh point 105A are receiving from wireless devices or mesh points other than 105A. Collectively, these fractions of times reflect the time durations necessary to transmit and/or receive wireless data flows already accepted and/or setup by the example wireless mesh network. In the illustrated example of FIG. 1, wireless communication in the neighborhood of mesh point 105A can be arranged, coordinated and/or scheduled if a sum of My_Transmit, My_Receive and Neighbor_Transmit is less than one (1) and if a sum of My_Transmit and Neighbor_Receive is also less than one (1). That is, if these conditions are met, then there is sufficient time to allow all accepted and/or setup wireless data flows to satisfy their required QoS parameters. These conditions can be expressed mathematically as shown in EQN(1) and EQN(2).
My_Transmit+My_Receive+Neighbor_Transmit<1 EQN(1)
My_Transmit+Neighbor_Receive<1 EQN(2)

FIG. 2 is an example resource allocation table having a plurality of entries 202. Each of the plurality of entries 202 has a reservation type 205 and a corresponding fraction of time entry 210. An example entry 215 has a reservation type 220 having a value of My_Transmit and a fraction of time value 220A. As illustrated in FIG. 2, the example table also includes entries for the other values discussed above: My_Receive, Neighbor_Transmit and Neighbor_Receive. The example resource allocation table may be stored via any variety of register(s), variable(s), table(s) and/or data structure(s). For example, the example entry 215 could be stored as a variable having a variable name of “My_Transmit” and having a value of fraction of time 220A.

In the example wireless mesh network of FIG. 1, time is broken into QoS Service Intervals (QSIs) to facilitate and/or support data and/or communication services requiring a specific QoS. For example, a device receiving a real-time video stream needs to receive the associated video data stream at a substantially consistent rate to avoid an interruption in the viewing of the video stream. The duration of the QSI may be uniquely defined for each wireless mesh network via, for example, a management information base (MIB) for the wireless mesh network by, for example, an operator of the wireless mesh network. An example wireless mesh network having a large number of mesh points and supporting interactive services that require low latency and low jitter may utilize a relatively small QSI value. However, for a smaller network with devices having relatively large buffering capabilities and desiring support of high data rate services such as video, the QSI may be chosen to have a relatively large value. The example fraction of time entries 210 in FIG. 2 represent the corresponding fraction of time as a fraction of the QSI configured for the example wireless network of FIG. 1.

Returning to FIG. 1, each of the example wireless mesh points 110A-D maintains and/or utilizes its own resource allocation values and/or table (e.g., the example resource allocation table of FIG. 2) that reflect the collection of wireless signals it is capable of receiving, transmitting and/or detecting. When a new wireless data flow is requested to be setup by the example wireless mesh network, any and/or all of example wireless mesh points of FIG. 1 are structured to reject the setup of the new wireless data flow if the new wireless data flow would cause the corresponding wireless mesh point to violate either of the conditions expressed in EQN(1) and EQN(2). If the new wireless data flow would not cause any of the wireless mesh points affected by and/or associated with a forwarding path to violate either condition (i.e., not impact the QoS of already accepted wireless data flows), then the new wireless data flow is setup and admitted to the example wireless mesh network. If the new wireless data flow is rejected, it may be re-attempted with identical and/or revised setup parameters.

In the example wireless mesh network of FIG. 1, wireless data flows can be unscheduled and/or scheduled. For an unscheduled data flow, each mesh point transmits and/or forwards the data flow based upon any variety of channel access mechanism(s). For example, the mesh point detects when the wireless channel is unused and then transmits the data flow having the highest priority. For a scheduled data flow, the mesh points are coordinated such that each mesh point is assigned a time at which the data flow is to be transmitted within each QSI. Thus, after verifying that the wireless channel is available, the mesh point transmits the data flow at its scheduled time. The end-to-end data flow setup methods and apparatus disclosed herein can be used for scheduled and/or unscheduled data flows.

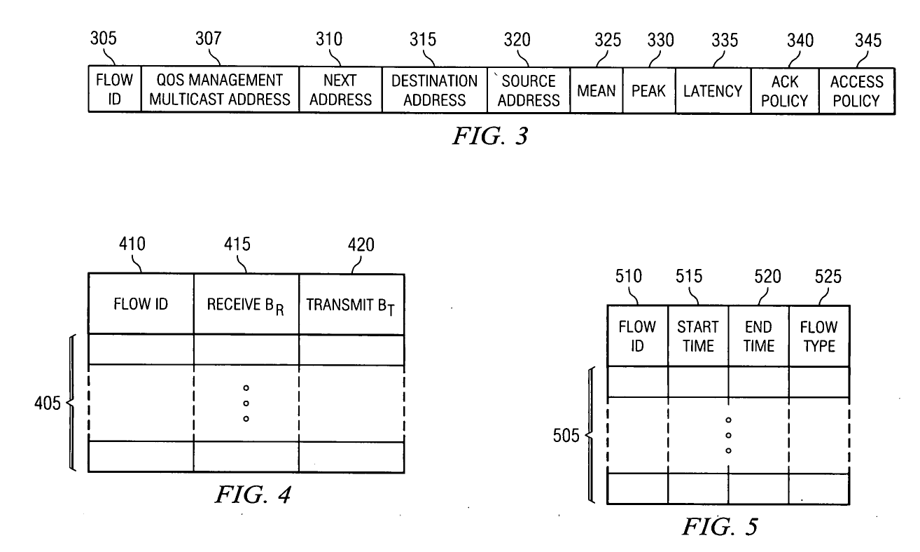

FIG. 3 illustrates an example flow setup request that contains traffic specifications (TSPECs) that allows each of the wireless mesh points to determine if a new unscheduled wireless data flow can be accepted without impacting the QoS of already accepted scheduled and/or unscheduled wireless data flows. The example flow setup request of FIG. 3 includes an identifier field 305 having a value that uniquely identifies the requested wireless data flow and a (QoS) Management Multicast Address field 307 specifying the multicast address used to transmit the flow setup request. If a setup request is being used to modify the TSPECs for an existing wireless data flow, the value in the identifier field 305 identifies the existing wireless data flow. To indicate origination, destination and next hop information for the new wireless data flow, the example setup request of FIG. 3 includes a next hop address field 310, a destination address field 315 and a source address field 320. The example address fields 310, 315 and 320 contain media access control (MAC) addresses in accordance with the format of IEEE 802.11 message protocol data units (MPDUs). The determination of origination, destination and/or next hop addressed may be determined using any variety of method(s) and/or technique(s).

To specify the data rate and/or characteristics of the new wireless data flow, the example request of FIG. 3 includes a mean field 325 representing the mean data rate of the data flow in bytes per QSI, a peak field 330 representing the peak data rate of the data flow in bytes per QSI, and a latency field 335 indicating the maximum latency in milliseconds that the data flow can accept and/or tolerate. To specify the acknowledgement (ACK) policy for the requested data flow, the example request of FIG. 3 includes an ACK policy field 340 to contain contents in accordance with the IEEE 802.11 standard. To indicate if the requested wireless data flow is scheduled or un-scheduled, the example request of FIG. 3 includes an access policy field 345.

Returning to FIG. 1, each wireless data flow setup request (e.g., the example setup request of FIG. 3) is sent using a variant of the format of the IEEE 802.11e add traffic stream (ADDTS) request that is relayed along the forwarding path of the wireless data flow as specified by, for example, the address fields 310, 315 and 320. In the illustrated example of FIG. 1, ADDTS requests are addressed and/or sent to the QoS Management Multicast Address 307 for the wireless mesh network. Further, to ensure that any wireless mesh point(s) implementing power saving states receive ADDTS requests, the example wireless mesh points of FIG. 1 send an IEEE 802.11 announcement traffic indication message (ATIM) frame in the ATIM interval preceding the sending and/or forwarding of an ADDTS request. Each of the example wireless mesh points of FIG. 1 are expected to be and/or stay awake for each ATIM interval to allow detection of the ATIM frame and, thus, to know when an ADDTS request needs to be received. In the example of FIG. 1, having received an ATIM frame indicating an ADDTS message is on it way, a power saving mesh point stays awake until either an ADDTS request is received via a multicast frame or until a target beacon transmission time (TBTT) occurs.

Consider an example setup and/or change of a new wireless data flow initiated by a wireless communication device (e.g., the PDA 110C) communicatively coupled to a wireless mesh point (e.g., the mesh point 105B). In the illustrated example, the example mesh point 105A detects the initiation and/or change of a wireless data flow via any variety of communication protocol implemented by and/or between the PDA 110C and the mesh point 105B. For example, the detection may be made in the media access control (MAC) layer of the network protocol stack implemented by the example wireless mesh point 105B. For purposes of discussion, the wireless mesh point 105B will be referred to as the “originating mesh point.”

Having detected the initiation of a request for a new unscheduled wireless data flow or a request to change one of the TSPEC parameters for an existing wireless data flow, the originating wireless mesh point (e.g., the mesh point 105B) determines if acceptance of the new and/or changed data flow would violate either of the conditions specified by EQN(1) or EQN(2) at the originating mesh point. In particular, the originating wireless mesh point 105B represents the new and/or changed average bandwidth of the data flow at the origination mesh point as a fraction Bₜ of the QSI. If the data flow is a new data flow, then Bₜ reflects the average bandwidth required for the new data flow. If the data flow is being changed, then Bₜ reflects the change in the average bandwidth of the changed data flow relative to the current average bandwidth of the data flow. In particular, the originating wireless mesh point 105B determines whether a new value of My_Transmit for the originating mesh point that includes Bₜ would still allow EQN(1) and EQN(2) to be satisfied. This can be mathematically expressed as shown in EQN(3) and EQN(4), where the values of My_Transmit, My_Receive, Neighbor_Transmit and Neighbor_Receive are taken from the resource allocation variables and/or table for the originating wireless mesh point 105B.
Bₜ+My_Transmit+My_Receive+Neighbor_Transmit<1 EQN(3)
Bₜ+My_Transmit+Neighbor_Receive<1 EQN(4)
If the inequalities shown in EQN(3) and EQN(4) are satisfied at the originating wireless mesh point 105B, the originating wireless mesh point 105B updates its value of My_Transmit to include Bₜ and stores the updated value in its resource allocation table to reserve resources for the new and/or changed data flow. The update of My_Transmit can be mathematically expressed as shown in EQN(5).
My_Transmit=Bₜ+My_Transmit EQN(5)
In the example of FIG. 1, is it not necessary to propagate the updated value of My_Transmit to the other mesh points.

Having accepted the new and/or changed data flow, the originating wireless mesh point 105B sends an ADDTS request (e.g., the example setup request of FIG. 3) along the forwarding path (e.g., to the mesh point 105A) and, thus, also to its neighbors via the QoS Management Multicast Address 307 as discussed above. If the new and/or changed wireless data flow cannot be accepted at the originating mesh point 105B (i.e., the inequality expressed in EQN(3) and/or EQN(4) does not hold at the originating mesh point 105B), then the example originating wireless mesh point 105B rejects the wireless data flow request and/or change, and notifies the PDA 110C of the rejection via the protocol stack implemented by the wireless mesh point 105B and the PDA 110C.

The wireless mesh point 105A (i.e., a neighbor of originating mesh point 105B and a forwarding mesh point for the requested flow setup) determines if acceptance of the new and/or changed data flow specified in the received ADDTS request would violate either of the conditions specified by EQN(1) or EQN(2). For purposes of discussion, the wireless mesh point 105A will be referred to as the “forwarding mesh point.” In particular, the forwarding wireless mesh point 105A represents the new and/or changed average bandwidth of the data flow as a fraction Bₜ at the forwarding mesh point 105A of the QSI necessary to forward (i.e., transmit) the requested data flow at the forwarding mesh point 105A. The forwarding mesh point 105A requires a fraction Bᵣ of the QSI to receive the data flow and a fraction Bₜ of the QSI to forward (i.e., transmit) the data flow. The values of Bᵣ and Bₜ may be the same or different depending upon the characteristics (e.g., transmission speed) of the wireless channel(s), transceiver(s) and/or radio(s) use to receive and transmit the dataflow. If the data flow is a new data flow, then Bᵣ and Bₜ reflect the fraction of the QSI necessary to receive and transmit the new data flow, respectively. If the data flow is being changed, then Bᵣ and Bₜ reflect the changes in the fraction of the QSI of the changed data flow relative to the current data flow. In particular, the forwarding wireless mesh point 105A determines whether a new value of My_Receive at the forwarding mesh point 105A that includes Bᵣ and new value of My_Transmit at the forwarding mesh point 105A that includes Bₜ would still allow EQN(1) and EQN(2) to be satisfied. This can be mathematically expressed as shown in EQN(6) and EQN(7), where the values of My_Transmit, My_Receive, Neighbor_Transmit and Neighbor_Receive are taken from the resource allocation variables and/or table for the forwarding wireless mesh point 105A.
Bᵣ+Bₜ+My_Transmit+My_Receive+Neighbor_Transmit<1 EQN(6)
Bₜ+My_Transmit+Neighbor_Receive<1 EQN(7)
If the inequalities shown in EQN(6) and EQN(6) are satisfied at the forwarding wireless mesh point 105A, the forwarding wireless mesh point 105A updates its value of My_Transmit to include Bₜ and its value of My_Receive to include Bᵣ, and stores the updates values in its resource allocation table to reserve resources for the new and/or changed data flow. The updates of My_Transmit and My_Receive for the forwarding mesh point 105A can be mathematically expressed as shown in EQN(8) and EQN(9).
My_Transmit=^{B}ₜ+My_Transmit EQN(8)
My_Receive=Bᵣ+My_Receive EQN(9)
Having accepted the new and/or changed data flow, the example forwarding wireless mesh point 105A then sends an ADDTS along the forwarding path to either the next forwarding mesh point along the forwarding path or to a destination mesh point (e.g., the mesh point 105C) via the QoS Management Multicast Address 307 as discussed above. As described above, the ADDTS will be received by neighbors of the forwarding mesh point 105A. If the new and/or changed wireless data flow cannot be accepted at the forwarding mesh point 105A (i.e., the inequality expressed in EQN(6) and/or EQN(7) does not hold for the forwarding mesh point 105A), then the example forwarding wireless mesh point 105A rejects the wireless data flow request and/or change, and sends an ADDTS response with a response code set to rejected back along the forwarding path (i.e., to the origination mesh point 105B) and, thus, also to the neighboring mesh points of forwarding mesh point 105A via the QoS Management Multicast Address 307. In the example of FIG. 1, the example forwarding wireless mesh point 105A also sends its resource allocation variables and/or table with the ADDTS rejection.

The method described above for the example forwarding wireless mesh point 105A is repeated at each forwarding mesh point along the forwarding path until the destination mesh point is reached. At the destination mesh point for the forwarding path (e.g., the destination wireless mesh point 105C), the destination mesh point 105C determines if acceptance of the new and/or changed data flow specified in the received ADDTS request would violate either of the conditions specified by EQN(1) or EQN(2). For purposes of discussion, the wireless mesh point 105C will be referred to as the “destination mesh point.” In particular, the example destination wireless mesh point 105C represents the new and/or changed average bandwidth of the data flow as the fraction Bᵣ of the QSI necessary to receive the request data flow at the destination mesh point 105C. If the data flow is a new data flow, then Bᵣ reflects the fraction of the QSI necessary to receive the new data flow. If the data flow is being changed, then Bᵣ reflects the change in the fraction of the QSI necessary to receive the changed data flow relative to the fraction required to receive the current data flow. In particular, the example destination wireless mesh point 105C determines whether a new value of My_Receive that includes Bᵣ would still satisfy the inequality shown in EQN(1) to be satisfied at the destination mesh point 105C. This can be mathematically expressed as shown in EQN(10), where the values of My_Transmit, My_Receive, Neighbor_Transmit and Neighbor_Receive are taken from the resource allocation variables and/or table for the destination wireless mesh point 105C.
Bᵣ+My_Transmit+My_Receive+Neighbor_Transmit<1 EQN(10)
If the inequality shown in EQN(10) is satisfied at the wireless mesh point 105C, the example wireless mesh point 105C updates the value of My_Receive to include Bᵣ (using, for example, EQN(9)) and stores the updated values in the resource allocation table to reserve resources for the new and/or changed data flow. The example wireless mesh point 105C then sends an ADDTS response with a response code of confirmed. If new and/or changed wireless data flow cannot be accepted (i.e., the inequality in EQN(10) does not hold), then the example destination wireless mesh point 105C rejects the wireless data flow request and/or change, and sends an ADDTS response with a response code set to rejected back along the forwarding path (e.g., to the forwarding mesh point 105A) and, thus, also to neighbors of the destination mesh point 105C via the QoS Management Multicast Address 307. In the example of FIG. 1, the example destination wireless mesh point 105C also sends a copy of its resource allocation variables and/or table with the ADDTS rejection response.

The wireless mesh point 105D (e.g., a non-forwarding neighbor of originating mesh point 105B) determines if acceptance of the new and/or changed data flow specified in the received ADDTS request received from the originating mesh point 105B would violate either of the conditions specified by EQN(1) or EQN(2) at the non-forwarding mesh point 105D. For purposes of discussion, the wireless mesh point 105C will be referred to as the “non-forwarding mesh point.” In particular, the example non-forwarding wireless mesh point 105D represents the new and/or changed average bandwidth of the data flow as the fraction Bᵣ of the QSI necessary to receive the requested data flow at the non-forwarding mesh point 105D. If the data flow is a new data flow, then Bᵣ reflects the fraction of the QSI necessary to receive the new data flow. If the data flow is being changed, then Bᵣ reflects the change in the fraction of the QSI necessary to receive the changed data flow relative to fraction of the QSI necessary to receive the current data flow. In particular, the example non-forwarding wireless mesh point 105D determines whether a new value of My_Receive that includes Bᵣ would still allow EQN(1) to be satisfied at the non-forwarding mesh point 105D. This can be mathematically expressed as illustrated above in EQN(10), where the values of My_Transmit, My_Receive, Neighbor_Transmit and Neighbor_Receive are taken from the resource allocation table for the wireless mesh point 105D. If EQN(10) is satisfied at the non-forwarding wireless mesh point 105D, the non-forwarding wireless mesh point 105D updates the value of My_Receive to include Bᵣ (using, for example, EQN(9)) and stores the updated values in its resource allocation table to reserve resources for the new and/or changed data flow. If new and/or changed wireless data flow cannot be accepted (i.e., EQN(10) does not hold), then the non-forwarding wireless mesh point 105D rejects the wireless data flow request and/or change, and sends an ADDTS response via the QoS Management Multicast Address 307 with a response code set to rejected to the sender of the ADDTS request (e.g., the originating mesh point 105B) and, thus, also to each of the neighbors of the non-forwarding mesh point 105D. In the example of FIG. 1, the non-forwarding wireless mesh point 105D also sends a copy its resource allocation table with the ADDTS rejection response. The methods described above for the non-forwarding wireless mesh point 105D are repeated for each non-forwarding wireless mesh point of the forwarding path of the new and/or changed data flow.

In the illustrated example of FIG. 1, if an origination wireless mesh point receives an ADDTS response with a response code of confirmed from the destination mesh point and does not receive any ADDTS responses with a response code of rejected, the originating mesh point assumes the requested wireless data flow to have been successfully setup and installs and/or initiates admission control for the new and/or changed data flow.

However, if after a set time period either (1) no ADDTS response with a response code of confirmed is received; or (2) an ADDTS response with a response code of rejected is received, the originating wireless mesh point rejects the wireless data flow request and/or change and notifies the wireless device of the rejection via the protocol stack implemented by the originating mesh point and the requesting wireless device. In the example of FIG. 1, when a data flow request is rejected, the originating mesh point sends any variety of delete traffic stream (DELTS) message to explicitly tear down the wireless data flow and, thus, release any resources reserved by any wireless mesh point during the distributed end-to-end flow setup process. The sending, forwarding and/or receiving of the DELTS message proceeds similarly to that described above for the data flow setup request. An example DELTS message includes the example flow ID field 305, the example QoS Management Multicast Address 307, the example next hop address field 310, the example destination address field 315 and the example source address field 320 described above in connection with FIG. 2.

FIG. 4 illustrates an example flow state table containing a plurality of flow state entries 405. In the example state table of FIG. 4, each of the entries 405 includes a flow identifier field 410 that identifies the data flow (e.g., a value of the example flow identifier field 305 of FIG. 3), a receive fraction Bᵣ field 415 containing the fraction of the QSI necessary to receive the data flow, and a transmit fraction Bₜ field 420 containing the fraction of the QSI necessary to transmit and/or forward the data flow. At an origination mesh point of a data flow, the received field 415 for the data flow will have a value of zero (0). Likewise, at a destination and/or non-forwarding mesh point of a data flow, the transmit field 420 for the data flow will have a value of zero (0).

Returning to FIG. 1, each wireless mesh point has its own flow state table (e.g., the example state table of FIG. 4). The wireless mesh points use their associated flow state tables to determine which wireless data flows are active and/or to determine how to adjust the values of My_Transmit and/or My_Receive when, for example, a data flow is torn down. The values of the receive fraction field 415 and/or the transmit fraction field 420 may also be used to determine the appropriate Bᵣ and/or Bₜ values for a request to change a wireless data flow. In the example of FIG. 1, when a wireless data flow is torn down and/or becomes inactive, each wireless mesh point removes the corresponding entry from its flow state table. Alternatively, each flow state table could include one or more additional fields that reflect the current state of each data flow.

Turning now to the distributed end-to-end flow setup for scheduled wireless data flows, FIG. 5 is an example resource schedule table having a plurality of entries 505. In the example wireless mesh network of FIG. 1, each of the wireless mesh points maintains its own resource schedule table. Each of the plurality of entries 505 has a flow identifier field 510 (e.g., the value of the example flow identifier field 305 of FIG. 3), a start time field 515 representing a transmission start time relative to the start of the QSI interval, an end time field 520 representing a transmission end time relative to the start of the QSI interval, and a flow type specifier field 525. In the example of FIG. 5, the flow type specifier field 525 contains a value indicating if the flow originates at the mesh point, is forwarded by the mesh point, terminates at the mesh point or is simply observed by the mesh point (i.e., the mesh point is a non-forwarding neighbor to the data flow). It will be readily apparent to persons of ordinary skill in the art that the example flow state table of FIG. 4 and the example resource schedule table of FIG. 5 could be implemented as a combined and/or single table.

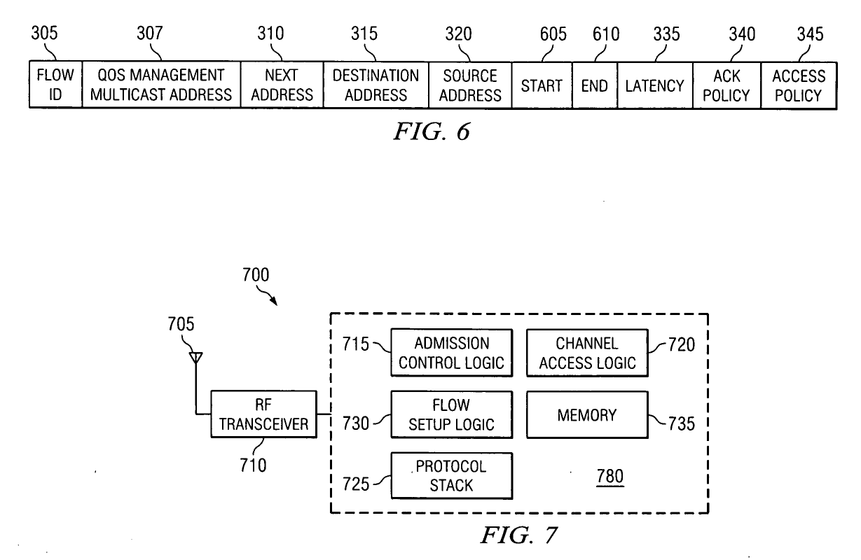

FIG. 6 illustrates an example flow setup request that contains traffic specifications (TSPECs) that allows each of the wireless mesh points to determine if a new scheduled wireless data flow can be accepted without unacceptably impacting the QoS of already accepted scheduled wireless data flows. The example setup request of FIG. 6 is substantially similar to the setup request shown and described above in conjunction with FIG. 3 and, thus, in the interest of brevity, the description of identical portions of FIG. 3 will not be repeated here. Instead, the interested reader is referred back to the corresponding description of FIG. 3. To facilitate this process, like elements have been numbered with like reference numerals in FIGS. 3 and 6.

To specify the transmission schedule of the new and/or changed wireless data flow, the example request of FIG. 6 includes a start field 605 representing the transmission start time of the new and/or changed data flow relative to the start of the QSI and an end field 610 representing the transmission end time of the data flow relative to the start of the QSI.

Returning to FIG. 1, the distributed end-to-end setup of a scheduled wireless data flow is similar to the distributed end-to-end setup of an unscheduled wireless data flow described above in connection with FIGS. 1-4. However, instead of using the example flow setup request of FIG. 3, the example flow setup request of FIG. 6 is used. Additionally, as each of the example wireless mesh points receives an ADDTS request for a scheduled data flow, the example wireless mesh point checks both the overall resource allocation using the methods described above for the distributed end-to-end setup of an unscheduled data flow and checks that a proposed schedule for the requested data flow does not conflict with any of the already scheduled data flows represented in the resource schedule table for the mesh point. In the examples of FIGS. 1 and 6 for a scheduled data flow, the fraction of QSI times used to verify that the requested data flow does not violate EQN(1) and EQN(2) can be determined from the values in the start field 605 and the end field 610. Alternatively, the ADDTS request can include both the unscheduled parameters (e.g., the mean field 325, the peak field 330 and the latency field 335 of FIG. 3) and the scheduled parameters (e.g., the start field 605 and the end field 610 of FIG. 6) to form a combined ADDTS request.

If there is a schedule conflict detected for the requested scheduled data flow at a wireless mesh point, the example wireless mesh point detecting the conflict sends an ADDTS reject response. The ADDTS reject response is propagated through the network as described above. In the example of FIG. 1, the resource allocation table and the resource schedule table are also sent with the ADDTS reject response. If there is no schedule conflict detected at a given wireless mesh point, the example given wireless mesh point updates its resource schedule table and its resource allocation table to include the new and/or changed data flow. If a given wireless mesh point is a forwarding mesh point for the request data flow, the example forwarding wireless mesh point selects a transmission start and end time to be used when forwarding (i.e., sending) the data flow, and then sends a corresponding ADDTS scheduled request (e.g., the example setup request of FIG. 6) to its neighbors via the QoS Management Multicast Address 307 as discussed above.

In the example wireless mesh network of FIG. 1, the setup of a data flow can be accomplished via any combination of scheduled and/or unscheduled hops. That is, a forwarding wireless mesh point can receive an ADDTS scheduled request, accept the request and then send an ADDTS unscheduled request to its neighbors. Additionally, a forwarding wireless mesh point can receive an ADDTS unscheduled request, accept the request and then send an ADDTS scheduled request to its neighbors.

In the illustrated example of FIG. 1, even if a schedule conflict is detected at a particular wireless mesh point, the entire data flow does not necessarily have to be rejected. Instead, in response to receiving an ADDTS rejection, a previous mesh point that requested the schedule can change the proposed schedule and then send the revised ADDTS scheduled request along the forwarding path and, thus, also to its neighbors. In this way, a rejection only need propagate back to a mesh point where the conflict can be resolved.

When a wireless data flow is accepted for scheduled transmission by an originating and/or forwarding mesh point, the example mesh point will perform channel sensing around the time it is scheduled to transmit the data flow. If the channel is available, the mesh point begins transmission. If the channel is available, the example mesh point continues sensing the channel. In the example of FIG. 1, other wireless mesh points in the neighborhood of the originating and/or forwarding mesh point have knowledge of the transmission schedule for the data flow and are expected to finish their unscheduled transmissions before the scheduled transmission time.

In the illustrated example of FIG. 1, a wireless data flow is torn-down by its originating wireless mesh point when the mesh point sends a DELTS message. Each wireless mesh point receiving and/or forwarding the DELTS message updates its resource allocation table, its resource schedule table and/or its flow state table to reflect that the data flow is now inactive. In particular, the values in the resource allocation table are adjusted to reflect that the data flow is inactive, any associated transmission and/or reception schedules are removed and/or marked as inactive in the resource schedule tables, and/or an associated entry in the flow state table is removed and/or marked as inactive. If the mesh point is an originating, forwarding or destination mesh point, the mesh point updates the value of My_Transmit by subtracting the value of Bₜ and updates the value of My_Receive by subtracting the value of Bᵣ. If the mesh point is a non-forwarding neighbor, the mesh point updates the value Neighbor_Transmit by subtracting the value of Bᵣ.

To ensure that wireless communication resources are not unintentionally tied up due to, for example, a missed DELTS message, a wireless mesh points that gets disconnected, etc., the example wireless mesh network of FIG. 1 implements any variety of bandwidth recovery schemes. For example, each originating mesh point could refresh its wireless data flows by periodically or a periodically re-issuing an ADDTS request with the existing TSPEC parameters (i.e., a keep-alive message). Assuming each flow setup has an associated maximum time duration, then sending the keep-alive ADDTS request approximately one-third of the way through the time window allows for each of the example mesh points to receive and refresh their resource allocation table, resource schedule table and/or flow state table. If any wireless mesh point does not receive a keep-alive message for a data flow during three successive time windows, the example wireless mesh point assumes the data flow can be torn down and updates their resource allocation table, resource schedule table and/or flow state table accordingly.

In another example, each wireless mesh point operates an inactivity timer for each of its active wireless data flows. Each time a packet for a data flow is received, the inactivity timer of the data flow is reset. If an inactivity time expires, the wireless mesh point declares the flow inactive, sends a DELTS message to its neighbors, and updates its resource allocation table, resource schedule table and/or flow state table accordingly.

While the above discussion assumed single-channel wireless transmissions, the methods described above can be readily adapted for use with multi-channel wireless mesh networks and/or for use with multiple radio (i.e., multiple transceiver) mesh points. Consider a wireless mesh network with N radios per mesh point and allowing operation on M wireless channels (i.e., frequencies). Like a single-channel mesh network, each mesh point cannot concurrently transmit and receive on the same radio nor on the same wireless channel. Moreover, two neighboring mesh points cannot transmit on the same wireless channel at the same time. To encompass these multi-channel and multiple radio restrictions, the example resource allocation table of FIG. 2 may be expanded to include a plurality of My_Transmit_R(n) values and a plurality of My_Receive_R(n) values that represent the fraction of time used to transmit and receive on each of the mesh points radios at each mesh point, where 1≦n≦N. The example resource allocation table is also expanded to include a plurality of My_Transmit_C(m) values, a plurality of My_Receive_C(m) values, a plurality of Neighbor_Transmit_C(m) values and a plurality of Neighbor_Receive_C(m) values that represent the fraction of time used to transmit and/or receive on each of the wireless channels at each mesh point, where 1≦m≦M. For a multi-channel and/or multi-radio wireless mesh network, EQN(1) and EQN(2) are correspondingly expanded into the mathematical expressions shown in EQN(11), EQN(12) and EQN(13).
My_Transmit_{—}C(m)+My_Receive_{—}C(m)+Neighbor_Transmit_{—}C(m)<1, for all m EQN(11)
My_Transmit_{—}C(m)+Neighbor_Receive_{—}C(m)<1, for all m EQN(12)
My_Transmit_{—}R(n)+Neighbor_Receive_{—}R(n)<1, for all n EQN(12)

The example setup requests of FIGS. 3 and 6 are expanded to include a wireless channel field that specifies the wireless channel to be used to receive the requested data flow. Like the single-channel case described above in connection with FIGS. 1-6, for a multi-channel and/or multi-radio wireless mesh network, a data flow can be accepted and/or setup at a wireless mesh point if each of the mathematical expressions of EQN(11), EQN(12) and EQN(13) are satisfied at the wireless mesh point. Additionally, a resource schedule table has to be maintained for each wireless channel and each radio. When a scheduled request is received, the example mesh points check the resource schedule table for the requested wireless channel.

FIG. 7 illustrates an example manner of implementing at least a portion of any of the plurality of example wireless mesh points 105A-D of FIG. 1. To support wireless communications with other wireless mesh points and/or wireless devices, the example mesh point 700 of FIG. 7 includes any of variety of wireless antenna(s) 705 and any variety of radio frequency (RF) transceiver(s) 710. In particular, the antenna 705 and the RF transceiver 710 are able to receive, demodulate and decode wireless signals transmitted to the mesh point 700 by, for example, other wireless mesh points and/or wireless devices. Likewise, the RF transceiver 710 and the antenna 705 are able to encode, modulate and transmit any variety of wireless signals from the example mesh point 700 to wireless mesh points and/or wireless devices. If the example mesh point 700 of FIG. 7 supports multiple radios, then the example mesh point 700 includes a corresponding multiple number of RF transceivers 710. The multiple RF transceivers 710 may share a common antenna 705 or each use a separate antenna.

To perform admission control, the example mesh point 700 of FIG. 7 includes any variety of admission control logic 715. Using any variety of methods and/or logic, the example admission control logic 715 monitors the data packets received and/or transmitted by the example mesh point 700 for each data flow to ensure the data flow complies with the TSPEC used to setup the data flow (e.g., complies with the value in the example mean field 325 and the example peak field 330 of FIG. 3).

To perform channel access control, the example mesh point 700 of FIG. 7 includes any variety of channel access logic 720. Using any variety of methods and/or logic, the example channel access logic 720 monitors received wireless signals to determine when a wireless channel is unused and determine which unscheduled data flow to transmit based upon their associated priorities.

To facilitate and/to or enable communication with communicatively coupled mesh points and/or wireless devices, the example mesh point 700 of FIG. 7 includes any variety of network protocol stack 725. In the illustrated example of FIG. 7, the admission control logic 715, the channel access logic 720 and the protocol stack 725 are implemented in accordance with the IEEE 802.11x family of standards.

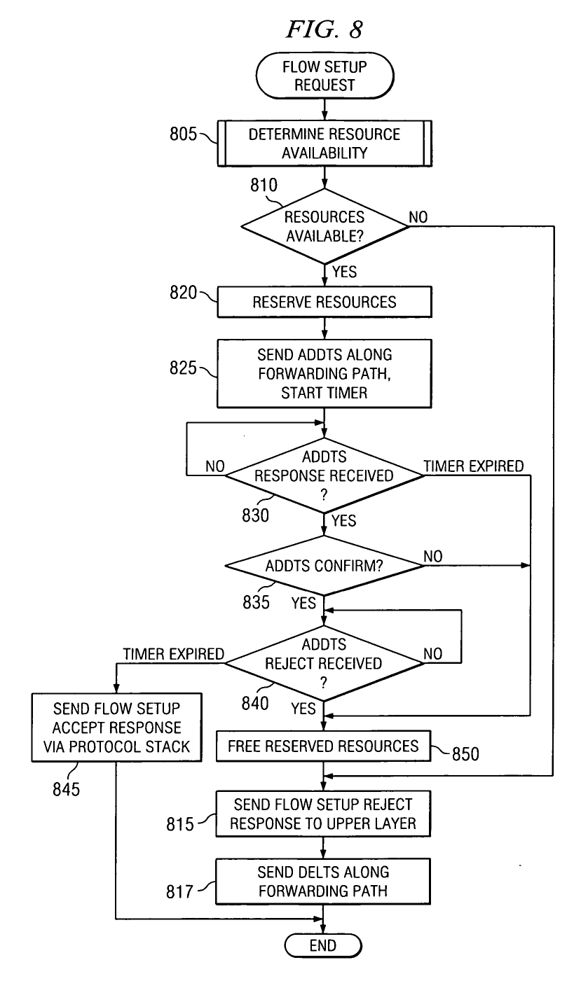

To perform flow setup for wireless data flows, the example mesh point 700 of FIG. 7 includes flow setup logic 730. The example flow setup logic 730 of FIG. 7 implements the flow control methods described above in connection with FIGS. 1-6 and/or as described below in connection the example machine accessible instructions of FIGS. 8-12.

To store the resource allocation table (e.g., the example resource allocation table of FIG. 2), the flow state table (e.g., the example flow state table of FIG. 4) and the example resource schedule table (e.g., the example resource schedule table of FIG. 5) for the example mesh point 700 of FIG. 7, the mesh point 700 includes a memory 735. The example memory 735 is any variety of random access memory (RAM) implemented by any variety of memory device(s) devices such as, for example, dynamic random access memory (DRAM), Synchronous DRAM (SDRAM), etc.

While an example mesh point 700 has been illustrated in FIG. 7, the elements, modules, logic, memory and/or devices illustrated in FIG. 7 may be combined, re-arranged, eliminated and/or implemented in any of a variety of ways. Further, the example admission control logic 715, the example channel access logic 720, the example protocol stack 725, the flow setup logic 730, the memory 735 and/or, more generally, the example mesh point 700 may be implemented by hardware, software, firmware and/or any combination of hardware, software and/or firmware. For example, the example admission control logic 715, the example channel access logic 720, the example protocol stack 725, the flow setup logic 730, the memory 735 may be implemented via machine accessible instructions executed by any variety of processor 750 such as, for example, a digital signal processor (DSP) from the TI® family of DSPs, an OMAP® processor from TI, an advanced reduced instruction set computing (RISC) machine (ARM) processor, etc. Moreover, a wireless mesh point may include additional elements, modules, logic, memory and/or devices and/or may include more than one of any of the illustrated elements, modules and/or devices.

FIGS. 8, 9, 10, 11 and 12 are flowcharts representative of example machine accessible instructions that may be executed to implement the example flow setup logic 730 of FIG. 7 and/or, more generally, the example flow setup methods described above in connection with FIGS. 1-6. The example machine accessible instructions of FIGS. 8-12 may be executed by a processor, a controller and/or any other suitable processing device. For example, the example machine accessible instructions of FIGS. 8-12 may be embodied in coded instructions stored on a tangible medium such as a flash memory, or RAM associated with a processor (e.g., the example central processing unit 1320 discussed below in connection with FIG. 13). Alternatively, some or all of the example flowcharts of FIGS. 8-12 may be implemented using an application specific integrated circuit (ASIC), a programmable logic device (PLD), a field programmable logic device (FPLD), discrete logic, hardware, firmware, etc. Also, some or all of the example flowcharts of FIGS. 8-12 may be implemented manually or as combinations of any of the foregoing techniques, for example, a combination of firmware and/or software and hardware. Further, although the example machine accessible instructions of FIGS. 8-12 are described with reference to the flowcharts of FIGS. 8-12, persons of ordinary skill in the art will readily appreciate that many other methods of implementing the example flow setup logic 730 of FIG. 7 and/or, more generally, the example flow setup methods described above in connection with FIGS. 1-6 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 8-12 may be carried out sequentially and/or carried out in parallel by, for example, separate processing threads, processors, devices, circuits, etc.

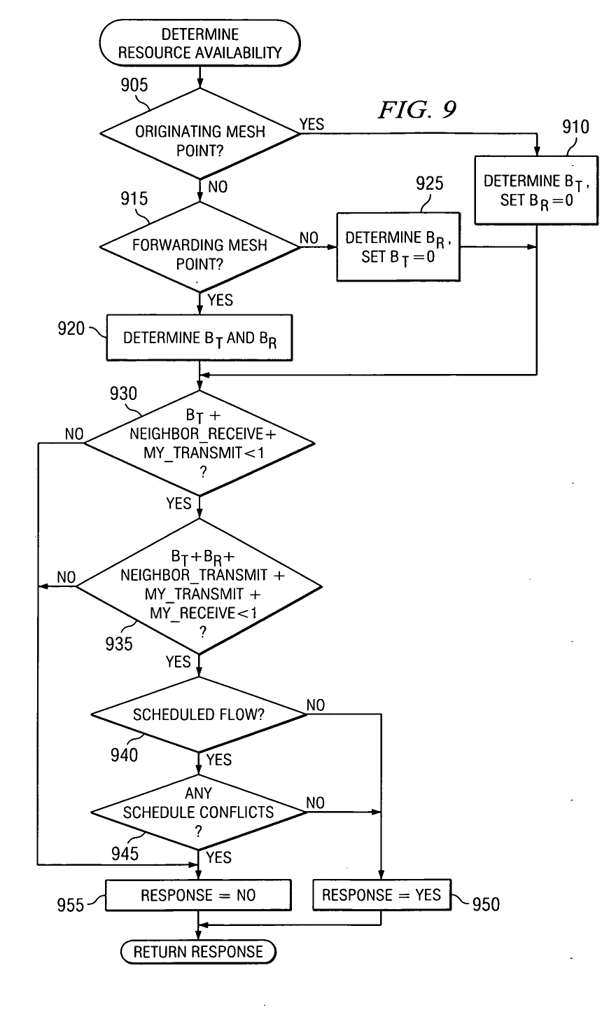

The example machine accessible instructions of FIG. 8 begin when an originating wireless mesh point detects via a network protocol stack that a wireless data flow is to be setup and/or changed. The originating mesh point determines if the new and/or changed data flow can be accepted by checking resource availability by, for example, implementing the example machine accessible instructions of FIG. 9 (block 805). If resources are not available (i.e., the new and/or changed data flow cannot be accepted) (block 810), the originating mesh point notifies the wireless device of the rejection via the protocol stack implemented by the originating mesh point and the wireless device (block 815). The originating mesh point then sends a DELTS message along the forwarding path (block 817) and control exits from the example machine accessible instructions of FIG. 8.

If the resource(s) are available (block 810), the originating mesh point updates its resource allocation table, resource schedule table and/or flow state table (block 820) and sends an ADDTS setup request along the forwarding path and, thus, also to its neighbors, and starts a timer (block 825). The origination mesh point then waits to receive ADDTS response message(s) (block 830).

When an ADDTS response message is received for the new and/or changed data (block 830), the originating mesh point determines if the ADDTS response contains a response code of confirmation (block 835). If an ADDTS confirm is received (block 835), the originating mesh point waits to see if any ADDTS rejects are received (block 840). When the timer expires (block 840), the origination mesh point sends a flow setup acceptance response via the protocol stack to the wireless device (block 845). Control then exits from the example machine accessible instructions of FIG. 8.

Returning to block 840, if an ADDTS rejection is received (block 840), the origination mesh point frees the reserved resources by updating its resource allocation table, resource schedule table and/or flow state table (block 850) and notifies the wireless device of the rejection via the protocol stack implemented by the originating mesh point and the wireless device (block 815). Control then exits from the example machine accessible instructions of FIG. 8.

Returning to block 835, if an ADDTS confirmation is not received (i.e., an ADDTS rejection is received) (block 835), the origination mesh point frees the reserved resources by updating its resource allocation table, resource schedule table and/or flow state table (block 850) and notifies the wireless device of the rejection via the protocol stack implemented by the originating mesh point and the wireless device (block 815). The originating mesh point then sends a DELTS message along the forwarding path (block 817) and control exits from the example machine accessible instructions of FIG. 8.

Returning to block 830, if the timer expires while waiting for an ADDTS response (block 830), the origination mesh point frees the reserved resources by updating its resource allocation table, resource schedule table and/or flow state table (block 850) and notifies the wireless device of the rejection via the protocol stack implemented by the originating mesh point and the wireless device (block 815). The originating mesh point then sends a DELTS message along the forwarding path (block 817) and control exits from the example machine accessible instructions of FIG. 8.

The example machine accessible instructions of FIG. 9 begin with a wireless mesh point determining if the mesh point is an originating mesh point (block 905). If the mesh point is an originating mesh point (block 905), the mesh point determines the value of Bₜ for the new and/or changed flow and sets the value of Bᵣ equal to zero. Control then proceeds to block 930.

If the mesh point is not an originating mesh point (block 905), the mesh point determines if the mesh point is a forwarding mesh point (block 915). If the mesh point is a forwarding mesh point (block 915), the mesh point determines the value of Bᵣ for the new and/or changed flow from the received ADDTS request and determines the value of Bₜ necessary to transmit the new and/or changed data flow (block 920). Control then proceeds to block 930.

Returning to block 915, if the mesh point is not an originating mesh point or a forwarding mesh point (e.g., a non-forwarding neighbor or destination) (block 915), the mesh point determines the value of Bᵣ for the new and/or changed flow from the received ADDTS request and sets the value Bₜ equal to zero (block 925). Control then proceeds to block 930.

At block 930, the mesh point checks if the inequality mathematically expressed in EQN(6) is satisfied (block 930). If the inequality of EQN(6) is satisfied (block 930), the mesh point checks if the inequality mathematically expressed in EQN(7) is satisfied (block 935). If the inequality of EQN(7) is satisfied (block 935), the mesh point determines if the ADDTS request is for a scheduled data flow (block 940). If the ADDTS request is for a scheduled data flow (block 940), the mesh point determines if the requested schedule conflicts with any existing scheduled data flows (block 945). If there are no schedule conflicts (block 945), control returns from the example machine accessible instructions of FIG. 9 to, for example, the example machine accessible instructions of FIG. 8 at block 805 with a response of ‘yes’ indicating that resources are available (block 950). If is a schedule conflict exists (block 945), control returns from the example machine accessible instructions of FIG. 9 to, for example, the example machine accessible instructions of FIG. 8 at block 805 with a response of ‘no’ indicating that resources are not available (block 955).

Returning to block 940, if the ADDTS request is for an unscheduled data flow (block 940), control returns from the example machine accessible instructions of FIG. 9 to, for example, the example machine accessible instructions of FIG. 8 at block 805 with a response of ‘yes’ indicating that resources are available (block 950).

Returning to block 935, if the inequality of EQN(7) is not satisfied (block 935), control returns from the example machine accessible instructions of FIG. 9 to, for example, the example machine accessible instructions of FIG. 8 at block 805 with a response of ‘no’ indicating that resources are not available (block 955).

Returning to block 930, if the inequality of EQN(6) is not satisfied (block 930), control returns from the example machine accessible instructions of FIG. 9 to, for example, the example machine accessible instructions of FIG. 8 at block 805 with a response of ‘no’ indicating that resources are not available (block 955).

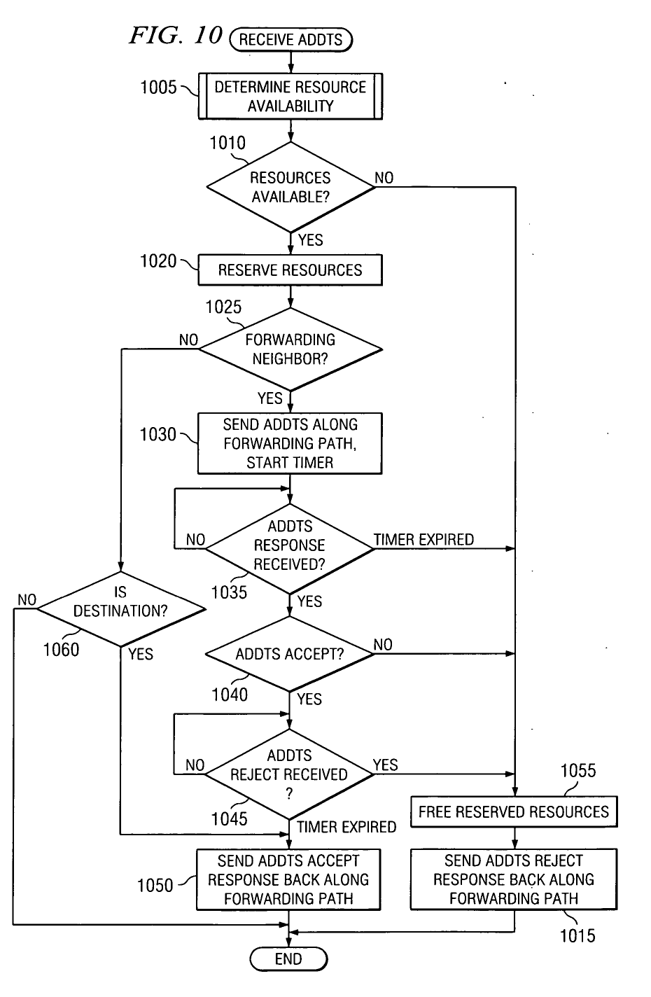

The example machine accessible instructions of FIG. 10 begin when a wireless mesh point receives an ADDTS request. The mesh point determines if the new and/or changed data flow can be accepted by checking resource availability by, for example, implementing the example machine accessible instructions of FIG. 9 (block 1005). If resources are not available (i.e., the new and/or changed data flow cannot be accepted) (block 1010), the mesh point sends an ADDTS rejection back along the forwarding path and, thus, also to its neighbors (block 1015). Control then exits from the example machine accessible instructions of FIG. 10.

If the resource are available (block 1010), the originating mesh point updates its resource allocation table, resource schedule table and/or flow state table (block 1020). The mesh point then determines if it is a forwarding mesh point (block 1025). If the mesh point is a forwarding mesh point, the mesh point sends an ADDTS setup request along the forwarding path and, thus, also to its neighbors, and starts a timer (block 1030). The mesh point then waits to receive ADDTS response message(s) (block 1035).

When an ADDTS response message is received for the new and/or changed data (block 1035), the mesh point determines if the ADDTS response contains a response code of confirmation (block 1040). If an ADDTS confirm is received (block 1040), the mesh point waits to see if any ADDTS rejects are received (block 1045). When the timerexpires (block 1045), the mesh point sends an ADDTS acceptance back along the forwarding path and, thus, also its neighbors (block 1050). Control then exits from the example machine accessible instructions of FIG. 10.

Returning to block 1045, if an ADDTS rejection is received (block 1045), the mesh point frees the reserved resources by updating its resource allocation table, resource schedule table and/or flow state table (block 1055) and sends an ADDTS rejection back along the forwarding path and, thus, also to its neighbors (block 1015). Control then exits from the example machine accessible instructions of FIG. 10.

Returning to block 1040, if the receive ADDTS response is not an ADDTS confirmation (e.g., an ADDTS rejection is received) (block 1040), the mesh point frees the reserved resources by updating its resource allocation table, resource schedule table and/or flow state table (block 1055) and sends an ADDTS rejection back along the forwarding path and, thus, also to its neighbors (block 1015). Control then exits from the example machine accessible instructions of FIG. 10.

Returning to block 1035, if the timer expires while waiting for an ADDTS response (block 1035), the mesh point frees the reserved resources by updating its resource allocation table, resource schedule table and/or flow state table (block 1055) and sends an ADDTS rejection back along the forwarding path and, thus, also to its neighbors (block 1015). Control then exits from the example machine accessible instructions of FIG. 10.

Returning to block 1025, if the mesh point is not a forwarding mesh point (block 1025), the mesh point determines if the mesh point is a destination mesh point (block 1060). If the mesh point is a destination mesh point (block 1060), the mesh point sends an ADDTS acceptance back along the forwarding path and, thus, also to its neighbors (block 1050). Control then exits from the example machine accessible instructions of FIG. 10. If the mesh point is not a destination mesh point (e.g., a non-forwarding mesh point) (block 1060), then control exits from the example machine accessible instructions of FIG. 10

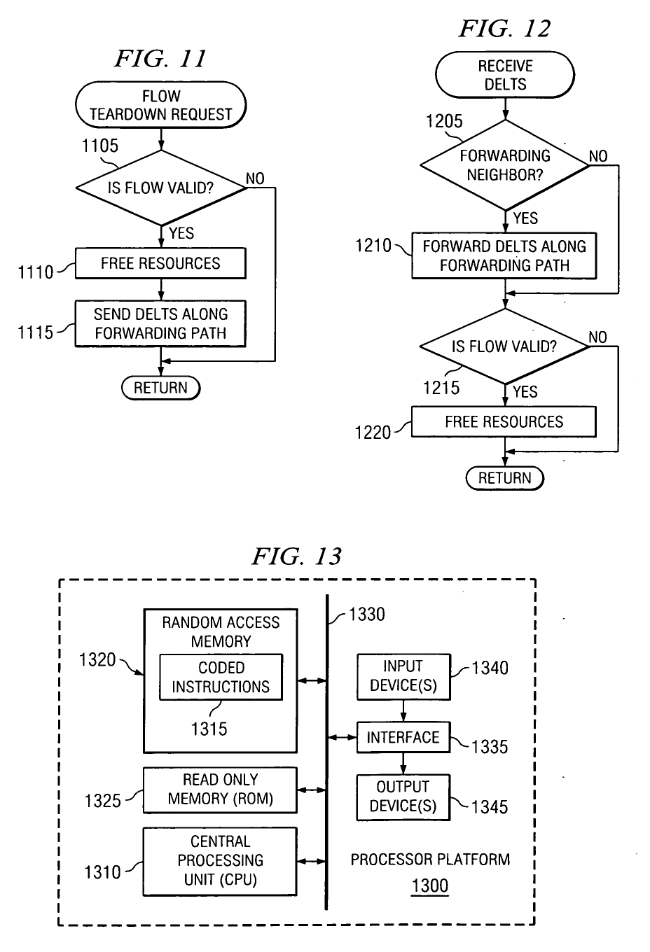

The example machine accessible instructions of FIG. 11 begin when a wireless mesh point detects via, for example, (a) a network protocol stack (b) receives an ADDTS rejection, or (c) lack of a keep-alive ADDTS request within a predetermined time period is not received that a wireless data flow needs to be torn-down. The mesh point determines if the data flow is active and/or valid by, for example, checking its flow state table (block 1105). If the data flow is active and/or valid (block 1105), the mesh point frees the reserved resources by updating its resource allocation table, resource schedule table and/or flow state table (block 1110) and sends a DELTS along the forwarding path and, thus, also to its neighbors (block 1115). Control then exits from the example machine accessible instructions of FIG. 11.

Returning to block 1105, if the data flow is inactive and/or invalid (block 1105), then control exits from the example machine accessible instructions of FIG. 11.

The example machine accessible instructions of FIG. 12 begin when a wireless mesh point receives a DELTS. The mesh point determines if the mesh point is a forwarding mesh point (block 1205). If the mesh point is a forwarding mesh point (block 1205), the mesh point forwards and/or sends a DELTS message along the forwarding path and, thus, also to its neighbors (block 1210). If the mesh point is not a forwarding mesh point (block 1205), the mesh point skips the sending of the DELTS message.

Continuing at block 1215, the mesh point determines if the data flow is active and/or valid by, for example, checking its flow state table (block 1215). If the data flow is active and/or valid (block 1215), the mesh point frees the reserved resources by updating its resource allocation table, resource schedule table and/or flow state table (block 1220). Control then exits from the example machine accessible instructions of FIG. 12.

Returning to block 1215, if the data flow is inactive and/or invalid (block 1215), then control exits from the example machine accessible instructions of FIG. 12.

FIG. 13 is a schematic diagram of an example processor platform 1300 that may be used and/or programmed to, for example, carry out the example machine accessible instructions illustrated in FIGS. 8-12 to implement the example flow setup logic 730 of FIG. 7 and/or, more generally, the example flow setup methods described above in connection with FIGS. 1-6. For example, the processor platform 1300 can be implemented by one or more general purpose microprocessors, microcontrollers, etc.

The processor platform 1300 of the example of FIG. 13 includes a general purpose programmable and/or specialized processor 1320. The processor 1320 executes coded instructions 1315 present in main memory of the processor 1320 (e.g., within a random access memory (RAM) 1310). The processor 1320 may be any type of processing unit, such as a DSP from the TI® family of DSP, an OMAP® processor from TI, an ARM processor, or any of a variety of processor or microcontroller. The processor 1320 may carry out, among other things, the example machine accessible instructions illustrated in FIGS. 8-12.

The processor 1320 is in communication with the main memory (including the RAM 1310 and a ROM 1325) via a bus 1330. The RAM 1310 may be implemented by DRAM, SDRAM, and/or any other type of RAM device. The ROM 1325 may be implemented by flash memory and/or any other desired type of memory device. Access to the memories 1310 and 1325 is typically controlled by a memory controller (not shown) in a conventional manner. The RAM 1310 and/or the ROM 1325 may be used, for example, to store the example resource allocation variables and/or table of FIG. 2, the example flow state table of FIG. 4 and/or the example resource schedule table of FIG. 5.

The processor platform 1300 also includes a conventional interface circuit 1335. The interface circuit 1335 may be implemented by any type of well-known interface standard, such as an external memory interface, serial port, general purpose input/output, etc.

One or more input devices 1340 and one or more output devices 1345 are connected to the interface circuit 1335. The input devices 1340 and output devices 1345 may be used, for example, to interface with the example RF transceiver 710 of FIG. 7.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of performing a distributed flow setup for a wireless mesh network comprising:
receiving a broadcast setup request for a wireless data stream at a first wireless mesh point of the wireless mesh network;
determining if the requested wireless data stream is acceptable at the first wireless mesh point based upon at least one of a resource allocation table associated with the first wireless mesh point or a resource schedule table associated with the first wireless mesh point;
sending a wireless data stream setup acceptance if the requested wireless data stream is acceptable; and
updating the at least one of the resource allocation table associated with the first wireless mesh point or the resource schedule table associated with the first wireless mesh point to reflect the requested wireless data stream if the wireless data stream is accepted by the first wireless mesh point.

2. A method as defined in claim 1, wherein the setup request is at least one of a flow setup request from a wireless device communicatively coupled to the first wireless mesh point, a flow setup request from a communication protocol stack, or an add traffic stream message received from a second or a third wireless mesh point.

3. A method as defined in claim 1, further comprising sending a wireless data stream setup rejection from the first wireless mesh point to a second wireless mesh point if the requested wireless data stream is not acceptable.

4. A method as defined in claim 1, wherein the wireless data stream setup rejection includes the at least one of the resource allocation table associated with the first wireless mesh point or the resource schedule table associated with the first wireless mesh point.

5. A method as defined in claim 1, further comprising:
determining if the first wireless mesh point is a forwarding mesh point; and
if the first wireless mesh point is a forwarding mesh point and if the wireless data stream is acceptable, forwarding the setup request to at least one neighbor of the first wireless mesh point.

6. A method as defined in claim 1, wherein the resource allocation table includes:
a first fraction of a time interval associated with signal transmission by the first wireless mesh point;
a second fraction of a time interval associated signal reception by the first wireless mesh point;
a third fraction of a time interval associated signal transmission by a wireless mesh point neighboring the first wireless mesh point; and
a fourth fraction of a time interval associated with signal reception by the neighboring wireless mesh point.

7. A method as defined in claim 6, wherein determining if the requested wireless data stream is acceptable at the first wireless mesh point based upon the at least one of the resource allocation table comprises checking that a first sum of a fraction of the interval for receiving the requested wireless data flow, the first fraction and the fourth fraction satisfies a first criteria.

8. A method as defined in claim 7, further comprising checking that a second sum of a fraction of the interval for transmitting the requested wireless data flow, the fraction of the interval for receiving the requested wireless data flow, the first fraction, the second fraction and the third fraction satisfies a second criteria.

9. A method as defined in claim 1, wherein the resource schedule table includes a plurality of entries for respective ones of a plurality of scheduled data flows, each entry including a flow identifier, a start time and an end time.

10. A method as defined in claim 9, wherein determining if the requested wireless data stream is acceptable at the wireless mesh point based upon the at least one of the resource schedule table comprises determining if a requested schedule for the requested wireless data stream conflicts with any of the plurality of scheduled data flows.

11. A wireless mess point apparatus comprising:
a memory to store a channel allocation table;
a wireless interface to receive a broadcast setup request for a wireless data stream; and
flow setup logic to:
determine if the requested wireless data stream is acceptable at the wireless mesh point based upon a resource allocation table;
send a wireless data stream setup acceptance if the requested wireless data stream is acceptable; and
update the resource allocation table to reflect the requested wireless data stream if the wireless data stream is accepted.

12. An apparatus as defined in claim 11, further comprising a memory to store a channel allocation table, the channel allocation table comprising:
a first entry representative of a first percentage of a quality of service (QoS) Service Interval (QSI) used by the apparatus to transmit one or more signals;
a second entry representative of a second percentage of the QSI used by the apparatus to receive one or more signals;
a third entry representative of a third percentage of the QSI used by the one or more additional wireless mesh points to transmit one or more signals; and
a fourth entry representative of a fourth percentage of the QSI used by the one or more additional wireless mesh points to receive one or more signals.

13. An apparatus as defined in claim 12, wherein the memory is configured to store a channel schedule table, and wherein the flow setup-logic is configured to determine if the requested wireless data stream is acceptable at the wireless mesh point based upon the resource allocation table and the resource schedule table.

14. An apparatus as defined in claim 13, wherein the channel schedule table comprises a plurality of entries for respective ones of a plurality of scheduled data flows, each entry including a flow identifier, a start time and an end time.

15. An apparatus as defined in claim 11, wherein the setup request is received from at least one of (1) a wireless device communicatively coupled to the wireless mesh point, (2) a second wireless mesh point, or (3) a communication protocol stack associated with the wireless interface.

16. An apparatus as defined in claim 11, wherein the flow setup-logic is configured to send a wireless data stream setup rejection if the requested wireless data stream is not acceptable.

17. An apparatus as defined in claim 11, further comprising:
admission control logic to perform traffic shaping to ensure an accepted wireless data stream satisfies its requested traffic parameters;
channel access logic to determine which of a plurality of accepted wireless data streams transmits at each time instant; and
a protocol stack to implement a layer protocol for reception and transmission of wireless data and wireless data streams via the wireless interface.

18. An apparatus as defined in claim 17, wherein at least one of the flow setup logic, the admission control logic, the channel access logic or the protocol stack are implemented by a processor executing machine accessible instructions.

19. An article of manufacture storing machine accessible instructions which, when executed, cause a machine to:
receive a broadcast setup request for a wireless data stream at a first wireless mesh point of a wireless mesh network;
determine if the requested wireless data stream is acceptable at the first wireless mesh point based upon at least one of a resource allocation table associated with the first wireless mesh point or a resource schedule table associated with the first wireless mesh point;
send a wireless data stream setup acceptance if the requested wireless data stream is acceptable; and
update the at least one of the resource allocation table associated with the first wireless mesh point or the resource schedule table associated with the first wireless mesh point to reflect the requested wireless data stream if the wireless data stream is accepted by the first wireless mesh point.

20. An article of manufacture as defined in claim 19, wherein the machine accessible instructions, when executed, cause the machine to:
determine if the first wireless mesh point is a forwarding mesh point; and
if the first wireless mesh point is a forwarding mesh point and if the wireless data stream is acceptable, forward the setup request to at least one neighbor of the first wireless mesh point.

21. An article of manufacture as defined in claim 19, wherein the resource allocation table includes:
a first fraction of a time interval associated with signal transmission by the first wireless mesh point;
a second fraction of a time interval associated signal reception by the first wireless mesh point;
a third fraction of a time interval associated signal transmission by a wireless mesh point neighboring the first wireless mesh point; and
a fourth fraction of a time interval associated with signal reception by the neighboring wireless mesh point.

22. An article of manufacture as defined in claim 19, wherein the resource schedule table includes a plurality of entries for respective ones of a plurality of scheduled data flows, each entry including a flow identifier, a start time and an end time.
